(19) United States
(12) Patent Application Publication
(10) Pub. No.: US 2013/0045317 A1
(43) Pub. Date: Feb. 21, 2013

(54) Method and Formulation for Producing Extruded Snack Food Products and Products Obtained Therefrom

(71) Applicants: Andres Victor ARDISSON-KORAT, Dallas, TX (US); Christina Lee COON, Plano, TX (US); David Wallice GRAHAM, Frisco, TX (US); Sander HOWARD, Dallas, TX (US); Iris HUANG, Plano, TX (US); Jorge C. MORALES-ALVAREZ, Plano, TX (US); Bharadwaj NARAYANAN, Plano, TX (US); Bulent OZTURK, Istanbul (TR); Ximena QUINTERO-FUENTES, Flower Mound, TX (US); V.N. Mohan RAO, Plano, TX (US); Passaporn SIRICURURATANA, Bangkok (TH); Richard Todd Smith, McKinney, TX (US); Sinem Gufran YURDAKAN-INCE, Istanbul (TR)

(72) Inventors: Andres Victor ARDISSON-KORAT, Dallas, TX (US); Christina Lee COON, Plano, TX (US); David Wallice GRAHAM, Frisco, TX (US); Sander HOWARD, Dallas, TX (US); Iris HUANG, Plano, TX (US); Jorge C. MORALES-ALVAREZ, Plano, TX (US); Bharadwaj NARAYANAN, Plano, TX (US); Bulent OZTURK, Istanbul (TR); Ximena QUINTERO-FUENTES, Flower Mound, TX (US); V.N. Mohan RAO, Plano, TX (US); Passaporn SIRICURURATANA, Bangkok (TH); Richard Todd Smith, McKinney, TX (US); Sinem Gufran YURDAKAN-INCE, Istanbul (TR)

(73) Assignee: FRITO-LAY NORTH AMERICA, INC., Plano, TX (US)

(21) Appl. No.: 13/213,722

(22) Filed: Aug. 19, 2011

(51) Int. Cl. A21D 13/08; A23P 1/14; A23P 1/12

(52) U.S. Cl. 426/550; 426/549; 426/559

(57) ABSTRACT

The present invention generally relates to the production of direct expanded farinaceous food products without the use of a drying apparatus such as an oven and without the use of traditionally used sugar to eliminate such drying steps. A farinaceous material combined with a plasticizer component in the form of trehalose is extruded to form a direct expanded shelf-stable snack food product. Snack food products made with trehalose can be incorporated into an outer shell of a composite center-filled or co-extruded product.

### BACKGROUND OF THE INVENTION

1. Technical Field

The present invention generally relates to the production of extruded farinaceous food products. In particular, the invention relates to direct expanded farinaceous food products that can be incorporated into savory extruded food products such as composite, center-filled snack foods, corn puffs or crackers and the method of preparing such extruded food products without the use of an oven or a similar post-extrusion thermal processing device to produce a final food product having desirable characteristics.

2. Background

Extruded filled snack products having a crisp baked outer dough shell are preferred by many consumers. FIG. 1, for example, depicts a method of producing co-extruded snack products with a crisp baked outer shell and a core filling of an edible paste-like or creamy material. Raw dry materials are first introduced along with water into a blender or mixer 10, thoroughly combining and moistening the dry ingredients. Blended and moisturized raw materials may be transferred via a bucket elevator 12 into an extruder hopper for transport into an extruder 14. The extruder 14 forms a continuous tube of extrudate (i.e., extruded material) with a filling in the center of the extruded tube. Co-filled extrudate is then conveyed through a pillow cutter 16 to help form or shape the extruded, filled dough tube into individual pieces, while sealing the filling inside each piece. Filled dough pieces are then conveyed on one or more conveyor belt(s) 18 to an oven 20, which bakes the products to provide for a desirable crisp baked texture of the outer dough shell and to produce a shelf-stable, ready-to-eat snack food product. Baked products can then transported into a coating tumbler 22, to be seasoned with oil-based slurries or covered with materials such as chocolate or similar coatings.

Because the method of FIG. 1 includes the use an oven 20, it is able to provide for desirable crisp baked textures in the manufacturing of both sweet and savory products. However, the method utilizes large amounts of space since the continuous baking requires the use of an oven 20 in its production line, which can be several hundred feet in length. The cost of having to use an oven to bake the goods adds to the cost of the snack food product in terms of both space and time. Thus, it is desirable to use a process that provides for continuous production of a snack food with a crisp, baked-like texture in a small amount of space and without having to wait for the drying times of an oven.

U.S. Pat. No. 4,869,911 to Keller describes an alternative method for producing food products that eliminates the use of an oven by using certain plasticizers. To date, however, methods for more closely mimicking the crisp texture of extruded farinaceous baked foods remain desirable.

There is a need in the art for alternative methods of producing direct expanded snack food products that eliminate lengthy and costly drying steps. Such methods should produce shelf-stable food products having a desirable crunchy texture that better imitates the texture resulting from conventional drying steps, while maintaining a low water activity. Such method should further allow for the production of savory extruded food products with a desirable savory taste, low water activity and crunchy texture. Moreover, there is a need for a method of producing savory filled snack food products with fillings that enhance or compliment the taste, texture and overall eating experience of savory extruded food products.

### SUMMARY OF THE INVENTION

The present invention generally provides for a method and composition for producing crispy, direct expanded, farinaceous food products without the use of post-extrusion thermal processing, which includes, for example, a drying step through an oven or similar device. The invention further provides for the production of expanded farinaceous food products without the incorporation of sweet sugars such as sucrose, glucose or fructose, while still providing for a desirable crunchy texture, which is otherwise typically achieved with use of such sugars.

In a first aspect, the present invention provides for an extrudable dough, which incorporates and utilizes a particular sugar called trehalose as a plasticizer to facilitate extrusion. The extrudable dough comprises or consists of a farinaceous food material and a plasticizer in the form of trehalose. After extrusion, the dough comprises a moisture content of between about 3.5% to about 5.5% and may be sent directly for packaging and subsequent consumption of a direct expanded farinaceous food product with a desirable texture.

In a second aspect, the present invention provides for a crisp, direct expanded farinaceous and ready-to-eat food product made from the extrudable dough containing trehalose. In one embodiment, the method and composition described herein provides for incorporation of the extrudable dough into a composite core-filled food product comprising a crisp, expanded farinaceous outer shell having an inner filling material disposed within the center of the outer shell. The outer shell may comprise any number of shapes including circular, triangular, quadrilateral, cylindrical, pillow-like or other designed shapes. Similarly, for example, the cross-section of the shape may comprise annular, rectangular, square-like, or oval shapes.

In general, the method for producing expanded farinaceous food products of the present invention comprises the steps of mixing a farinaceous food material with a plasticizer component in the form of trehalose to form a trehalose-containing mixture; extruding said trehalose-containing mixture; and forming the extruded mixture into a snack food product. Forming may include shaping or cutting steps or both shaping and cutting steps, whether performed simultaneously or sequentially. Following formation, the snack food product may be sent directly for optional seasoning and/or packaging. The invention provides for batch and continuous methods.

Other aspects, embodiments and features of the invention will become apparent from the following detailed description of the invention when considered in conjunction with the accompanying drawings. The accompanying drawings are schematic and not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a prior art method of producing a savory co-extruded snack food product

FIG. 2 is a flow chart representation depicting the overall process of one embodiment of the invention.

FIG. 3a depicts a perspective view of one embodiment of a shelf-stable, ready-to-eat snack food product of the present invention.

FIG. 3b depicts a cross section of the snack food product along line 3b-3b of FIG. 3a.

### DETAILED DESCRIPTION

Extruded snack food products may comprise many different ingredients. Sugar is one of the most complicated raw materials for extrusion. It is generally known that sweet sugars such as sucrose, glucose, and fructose, or a combination thereof, can be used in the manufacturing of expanded farinaceous products without the use of conventional secondary drying or post-extrusion thermal steps. These sugars eliminate the need to add water to a farinaceous mixture while allowing for subsequent elimination of a drying oven step in the production of direct expanded farinaceous food products. Despite the lack of oven or other post-extrusion thermal processing steps, these sugars produce desirable baked characteristics in terms of flavor, color and texture. Until now, such sugars were combined or substituted in whole or in part with corn syrup solids or maltodextrins, which are only slightly sweet, to produce a savory food product without the use of oven or post-extrusion thermal processing steps. However, such formulations still fall short in terms of texture and can adversely affect the eating experience. During test runs, for example, it was found that the same product attributes achieved when using sweet sugars could not be obtained with significant amounts of maltodextrin without conventional baking methods.

While theoretically a good alternative to be used as a plasticizer, the use of maltodextrin resulted in two disadvantages. First, with respect to product attribute, the use of maltodextrin even at a low percentage of about 5% resulted in airy, puffy and extremely soft and undesirable product texture. Second, with regard to processing, the highly hygroscopic nature of maltodextrin resulted in undesirable caking or clumping during ingredient storage, mixing and conveyance. Thus, it has been difficult to achieve a desirable hardness and crunchiness similar to that typically achieved when secondary drying steps such as baking are performed, without incorporating the more conventional, sweet sugar. The inventors of the present invention have found, however, that the use of a specific sugar called trehalose in lieu of previously used sugars creates direct expanded food products having a desirable crunchy texture similar to that achieved with a drying oven. In fact, it was found that trehalose need not be combined with any other plasticizer to produce a favorable texture for both sweet and savory direct expanded snack food products while producing a lower sweetness level for favorable flavor.

According to the present invention, a plasticizer component in the form of trehalose is added to a farinaceous food material to form a trehalose-containing mixture. The incorporation of trehalose has been found to provide for an extrudable mixture, which is easily conveyed with an auger. In one embodiment, the trehalose-containing mixture of the present invention may comprise a farinaceous food material together with a single plasticizer in the form of trehalose. Preferably, the mixture is extruded and thereafter formed into snack food pieces, which may be sent for seasoning and/or packaging directly after extrusion and without having to undergo post-extrusion thermal processing or secondary drying step such as heating or baking in an oven. Although bypassing these post-extrusion steps, resulting snack food products comprise a desirable finished product moisture and texture, as will be further discussed below.

Trehalose is a disaccharide formed by a 1,1-glucoside bond between two α-glucose units. Trehalose has about 45% of the sweetness of sucrose and is less soluble than sucrose. It is a low hygroscopicity and highly stable sugar with a clean sweetness profile having an initial onset of sweetness but no prolonged aftertaste. Suitable trehalose for use as a food ingredient with the present invention may be obtained from any number of sources or methods including without limitation methods of manufacturing from yeasts or starches. Trehalose is also commercially available, for example, under the trade name TREHA™, manufactured by Cargill®, Incorporated.

As used herein, a farinaceous food material is any meal, flour, or starch derived from corn, wheat, rice, oats, barley, potatoes, rye, tapioca, or other cereal crops, legumes or tubers, and any mixture thereof. Generally, the farinaceous food material will be in granular or powdered form. Suitable farinaceous materials as described herein are commercially available from any number of manufacturers. In one embodiment, the farinaceous food material comprises a cornmeal. In some embodiments, the farinaceous food material may comprise one or more types of corn meal including without limitation yellow, white, blue, whole-grain, degermed or any mixtures thereof. Such mixture in one embodiment, for example, may comprise whole grain corn meal together with corn meal at a ratio of between about 2:1 to about 3:1.

As used herein a “ready-to-eat” food product refers to a food product, which after manufacturing and packaging, requires no additional processing including but not limited to cooking, baking, microwaving, boiling, frying, or any combination thereof. Ready-to-eat food products further require no combination with any components outside of the product packaging before being consumed.

An extrudable dough of the present invention thus comprises a farinaceous food material and a plasticizer in the form of trehalose, with a moisture content of less than about 5.5%. In one embodiment, the extrudable dough comprises between about 5% to about 25% trehalose. In one embodiment, the extrudable dough comprises between about 14% to about 18% trehalose. In another embodiment, the extrudable dough comprises between about 16% to about 17% trehalose. In one embodiment, a crisp, direct expanded food product made from the extrudable dough comprises a water activity of between about 0.25 to about 0.5 and between about 3% to about 15% total sugars. The total sugars are derived in part from trehalose. In one embodiment, the total sugars range from between about 5% to about 13%. In one embodiment, the total sugars range from between about 8% to about 12%. In one embodiment, the water activity of the finished, ready-to-eat product ranges from about 0.28 to about 0.36. In another embodiment, the water activity ranges from between about 0.30 to about 0.34.

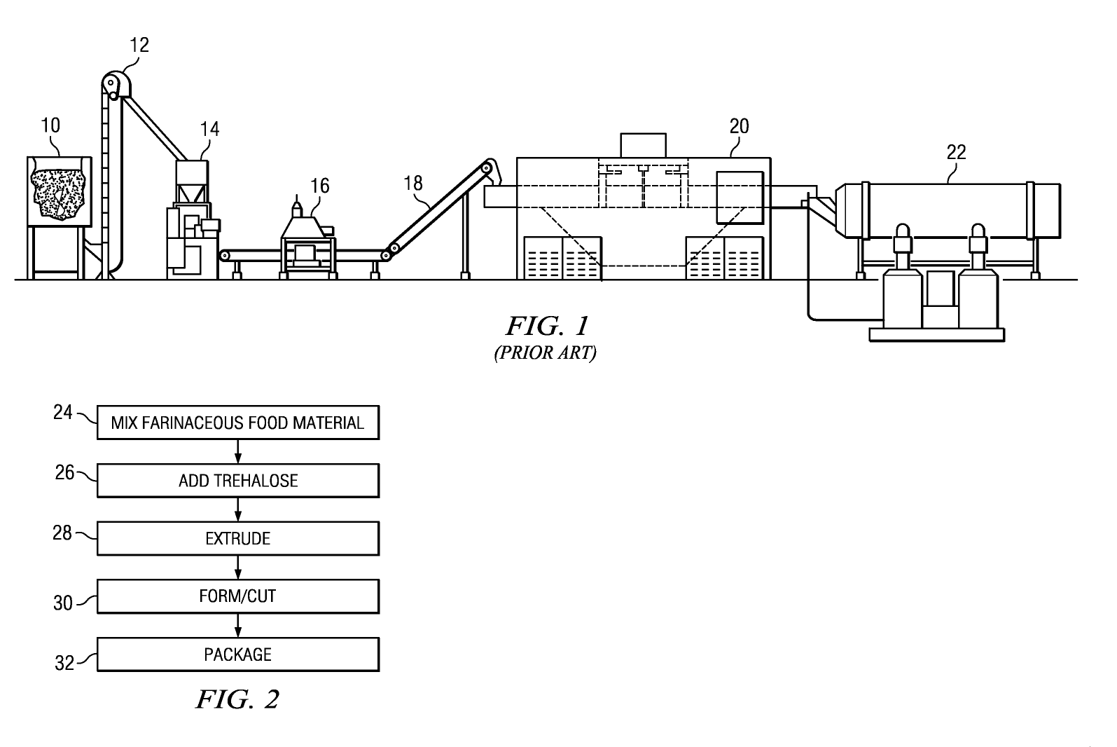

The method of the present invention will now be described with reference to FIG. 2. First, a farinaceous food material and water are added into a blender or similar mixing apparatus for mixing 24 to form a moistened farinaceous food mixture. Suitable mixing can be performed in vertical or horizontal blenders, for example, or in a ribbon blender such as that described in FIG. 1 at reference numeral 10. Preferably, no more than about 5 liters of water per 100 pounds of dry blend is added. In one embodiment, the farinaceous food material to water ratio is between about 1:10 to about 1:5. Once a moistened farinaceous mixture is attained, a plasticizer component in the form of trehalose is added to the blending mixture to form a trehalose-containing mixture 26. The resulting trehalose-containing mixture generally comprises a conveyable consistency. Preferably, the resulting mixture after blending comprises a moisture content of about between about 11% to about 15%. The principal ingredients alone may contain up to 15% by weight of inherent aqueous moisture, or more preferably between about 7% to about 15%.

In one embodiment, the trehalose-containing mixture comprises between about 5.0% to about 25% trehalose. In another embodiment, the trehalose-containing mixture comprises between about 14% to about 18% trehalose. In another embodiment, the trehalose-containing mixture comprises between about 16% to about 17% trehalose.

Generally, the trehalose-containing mixture may comprise between about 50% to about 95% of a farinaceous food material. In one embodiment, the trehalose-containing mixture comprises between about 75% to about 95% farinaceous food material. In some embodiments, the trehalose-containing mixture may comprise between 0 to about 95% legume-based ingredients. In one embodiment, the trehalose-containing mixture may comprise between 0 to about 60% legume-based ingredients. As used herein, farinaceous food materials include starch-based materials including without limitation meals, flours and starches derived from cereals, wheat, rye, corn, rice, oats, barley, buckwheat, tapioca and oats. In one embodiment, the trehalose-containing mixture comprises from about 50% to about 95% of a corn meal. In another embodiment, the trehalose-containing mixture comprises from about 20% to about 65% corn meal. In another embodiment, the trehalose-containing mixture comprises from about 25% to 35% corn meal. In another embodiment, the trehalose-containing mixture comprises from about 30% to about 65% whole grain corn meal. In one embodiment, the trehalose-containing mixture comprises between about 55% to about 60% whole grain corn meal. As previously discussed, the farinaceous material of the trehalose-containing mixture may also comprise more than one type of corn meal in alternate embodiments. Thus, in other embodiments, the farinaceous food material may comprise, for example, both corn meal and whole grain corn meal in any of the disclosed ranges such as one comprising or consisting of between about 20% to about 65% corn meal and between about 30% to about 65% whole grain corn meal. Aside from the farinaceous food component, the remainder of the mixture may comprise or consist of trehalose.

In one embodiment, the trehalose-containing mixture further comprises between about 0.01% and at least 5.0% of one or more sweetness maskers. Optionally, additional additives can be combined with the farinaceous food material or into a trehalose-containing mixture in minor amounts as necessary to produce further desirable effects. For example, minor amounts (>5%) emulsifiers, salt, fats, food coloring dyes, flavorings, Maltodextrin, microcrystalline cellulose, or calcium carbonate may also be present in the food material to be blended with the trehalose.

The trehalose-containing mixture 26 may then be fed into an extruder 28 by any means known in the art. For example, the conveyable mixture may be fed into an extruder using a volumetric or gravimetric feeder. In the practice of this invention, several high shear extruder types may be used. In one embodiment, a single screw extruder is used. Suitable single screw extruders are commercially available, for example, from American Extrusion International. A conventional extruder nozzle assembly generally comprises an outer extrusion conduit having an inlet for receiving dough and an outlet for discharging dough in a tubular shape. Thus, in one embodiment, the trehalose-containing mixture is extruded 28 through an outlet for discharging into a tubular shape for subsequent processing. However, other outlets designed to shape the extruded mixture into different or more complex shapes may also be used, including without limitation circular “O” shapes, triangular shapes, pillow shapes, or X-shaped pieces, whether hollow or solid. In an embodiment continuously manufacturing the snack food products of the present invention, the trehalose-containing mixture may be fed into the extruder at a rate of about 250 to about 350 pounds/hour in one embodiment, or up to 800 pounds/hour in another embodiment.

In one embodiment, the extruder further comprises an inlet for receiving filling material and an outlet for discharging the filling material inside, as enrobed by the tubular shaped extrudate. In such embodiments, the outer tubular shaped dough extrusion surrounds the filling and may be further processed into composite, co-extruded snack food products.

In some cases, external heat may be applied to the extruder to maintain the fluidity of the trehalose-containing mixture as it is conveyed. External heat may be applied by any means known in the art including without limitation use of one or more of the following: an electrical die band heater, a temperature-controlled die, an induction heater, an electrical cartridge, or an internal control mechanism such as providing heating fluid through a manifold inside the die and any other similar means of heating the extruder barrel, or any combination of the aforementioned list. In one embodiment, it may be desirable to raise or maintain the temperature of the extruder at between about 100° C. to about 250° C. (400° F.). In another embodiment, the temperature can be between about 140° C. to about 180° C. In another embodiment, the temperatures could be within about 115° C. to about 125° C.

Acceptable screw speeds of the extruder may be from about 250 rpm to about 650 rpm. In one embodiment, the screw speed may range from about 250 rpm to about 450 rpm.

As previously described, the trehalose-containing mixture does not require the use of a drying apparatus such as an oven or other post-extrusion thermal processes. In addition, the trehalose-containing mixture does not require any addition of water during extrusion, as it benefits from the use of the trehalose as plasticizer. As it emerges from the die, the tubular extrudate has a temperature of about 120° C. to about 190° C., and a moisture content of between about 3.5% to about 5%. Regardless of the extruder system used, the extrudate may be formed into a long tube or ribbon or any other shape that can be cut or shaped into a ready-to-eat snack food product, which sets shape upon cooling. The extrudate is soft, yet self-supporting and able to set into its shape. In one embodiment, a filling is inserted into the center of the tubular extrudate during or just after extrusion 28. The product can be subjected to further processing such as forming or cutting 30 or shaping by any other means known in the art to produce a plurality of smaller (bite-sized) snack food products. A cut may be made either directly at the die face or almost immediately thereafter, such as at some subsequent small distance following the exit from the die face before the product cools.

In one embodiment, forming may comprise attaching a post-forming apparatus at the die exit to compress or shape the product to a desired diameter, containing the expansion as it exits the die or forming the plasticized, farinaceous food mixture into a desired cross-sectional configuration with a profile die. Alternatively, the product may be formed into a desired shape with crimper or cutter rolls having any number of shapes or designs. Forming may further comprise the use of a pillow cutter as described with reference to FIG. 1. Once formed 30, the product may immediately be sent for optional seasoning steps before packaging 32 and/or subsequent consumption. In one embodiment, the method may further comprise coating extruded snack food products before packaging.

In one embodiment of the present invention, a filling material is introduced into the center of the product as it exits the extruder, such that core-filled shelf-stable products are formed. The introduction of the filling material into the extruded product can be performed by any means known in the art including by way of example and without limitation an annular co-axial tube for co-extrusion or other post-filling methods. However, care should be taken to ensure that the maximum temperature of the filling is about 55° C. to about 60° C. to prevent undesirable burning of the filling material. The filling material may comprise a sweet or savory taste.

The composition for a filling material of center-filled foods as described herein provides for an improved creaminess and mouthfeel, while containing no more than 2 grams of saturated fat in some embodiments, or less than 1 gram of saturated fat per in other embodiments based on a 1-oz. serving size. Generally, the filling material comprises a shortening together with a seasoning powder and an oil. Preferably, the filling material comprises between about 5% to about 25% by weight shortening. In one embodiment, the filling material comprises about 15% shortening. In one embodiment, the filling material comprises from about 40% to about 70% by weight seasoning powder. In another embodiment, the filling material may comprise about 60% seasoning powder. In one embodiment, the seasoning powder comprises a cheese. Other suitable seasoning powders may include without limitation cocoa, peanut butter, dehydrated fruit powders, cheddar cheese, sharp cheddar, mozzarella, milk powders, chili pepper, capsaicin, chocolate (milk, dark or white), maple syrup, caramel, bacon, jalapeno, tomato, pizza, BBQ or any other flavor. In one embodiment, the oil may be present at a range of between about 15% to about 35% by weight of the filling material. In another embodiment, the filling material comprises about 25% oil. Suitable oil can include, for example, corn oil, vegetable oil, and fully or partially saturated oils. Components of the filling material may be combined or mixed together in any number of mixers. Additional optional ingredients that may be included in the filling material of the present invention may comprise emulsifiers, salt, corn syrup solids, or maltodextrin.

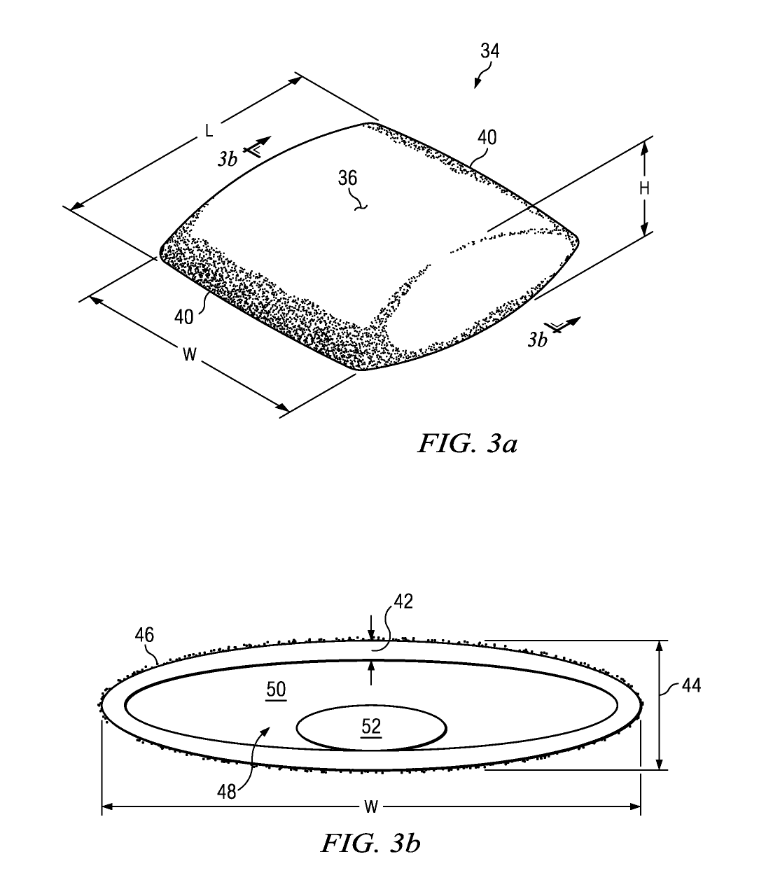

FIGS. 3a and 3b depict one embodiment of a ready-to-eat, shelf-stable (i.e., final) savory food product. FIG. 3a depicts a perspective view of a composite core-filled food product 34 of the present invention comprising a crisp, expanded farinaceous outer shell 36 with crimped ends 40. The food product 34 comprises a length L that spans from the crimped ends 40 of either side of the product, and a width W. FIG. 3b depicts a cross sectional view of the product 34 taking along line 3b-3b of FIG. 3a. As shown in FIG. 3b, the core-filled product comprises a shell wall thickness 42, referring to the thickness of the outer shell 36 surrounding the core of the food product, referred to as the “total volume inside the shell” 48, which contains a void space 50 and a filling material 52. As used herein, the void space 50 refers to the cavity or total open area within the total volume inside the shell, which is not otherwise occupied by the filling material 52. The product 34 further comprises an overall thickness 44. Optionally, the product may further comprise a seasoning layer 46 surrounding the shell 36. It should be noted that while FIGS. 3a and 3b depict a core-filled food product, one skilled in the art armed with this disclosure would recognize that a hollow product similar to FIG. 3a having a void space 50 equal to the total shell volume 48 could also be produced with the methods described herein by omitting the step of including a filling material 52 therein. In addition, it should be understood that crimped ends are optional and depend upon the cutting methods used to form the products.

In general, a food product as depicted in FIGS. 3a and 3b may vary in both size and shape depending upon the forming method or step used. The thickness 44, shell wall thickness 42, and void space 50 may also vary depending upon forming steps. However, in one embodiment, the food product may comprise, for example, a length L and a width W of between about 0.8 to about 1.0 inches, with the width W just slightly shorter than the length L if measuring L from crimped end to crimped end. By way of further example, in one embodiment, the thickness 44 may range from about 0.39 to about 0.41 inches. In one embodiment, the shell wall thickness 42 may range from about 0.08 to about 0.1 inches. In one embodiment, the void space 50 may range from about 0.10 to about 0.14 in³. In one embodiment, the ratio of thickness 44 to width W may range from about 0.409 to about 0.454. In one embodiment, the ratio of shell thickness 42 to width W may range from about 0.09 to about 0.1. In one embodiment, the ratio of the volume of the filling material 52 to the total volume inside the shell 48 is from about 0.25 to about 0.35. In another embodiment, the ratio of the volume of the filling material 52 to the total volume inside the shell 48 is from about 0.25 to about 0.27.

When analyzed for hardness by measuring the amount of force required to crack the outer shell with a 4 mm diameter flat tip puncture probe using a Texture Analyzer Model TX-XT2 set a speed of 20 mm/s, a direct expanded food product of the present invention, comprises a force to break of from about 1.75 lb force to about 3.5 lb force. In one embodiment, the direct expanded food product of the present invention comprises a force to break of from about 2.18 lb force to about 3.41 lb force. In another embodiment, the direct expanded food product of the present invention comprises a force to break of from about 3.0 lb force to about 3.5 lb force.

The porosity of the outer shell as a percentage of air to starch matrix of the food product ranges from about 64% to about 77% in one embodiment. In another embodiment, the porosity may range from about 71% to about 75%. In another embodiment, the porosity may comprise about 74.7% porosity. The bulk density of the product may range from about 12.5 to about 15.0 pounds per cubic feet. In another embodiment, the bulk density may range from about 12 to about 13 pounds per cubic feet.

Generally, food products of the present invention comprise a water activity of from about 0.25 to about 0.5. In one embodiment, the water activity is about 0.3 to about 0.4. In one embodiment, the water activity is about 0.28 to about 0.33. Water activity, which is the ratio of the fugacity of water in the substance being studied (i.e., the crisp, direct expanded farinaceous product) to the fugacity of pure water, can be considered to be a measure of the tendency of the substance to allow water migration. The low water activity of the products disclosed herein contribute to their excellent shelf-stability, particularly when the product is in the form of a composite with a filling material wherein it is important to prevent migration of moisture between the two materials. In addition, the texture of savory products produced by the present invention comprises an improved texture (i.e., crunchiness and harness) over prior attempted productions of savory extruded products with post-extrusion thermal processing steps in general; and in particular, when savory co-extruded or center-filled snack food products are desired. Moisture content of the final food product may range from about 2.5% to about 4.75% in one embodiment. In another embodiment, the moisture content may be from about 3.9% to about 4.6%.

Savory direct expanded food products of the present invention generally comprise less than 15% total sugars. In one embodiment, the food product comprises between about 2.5% to about 15% total sugars. In another embodiment, the food product comprises between about 5% to about 13% total sugars. In another embodiment, the food product comprises between about 8% to about 12% total sugars. The total sugars are derived in part from trehalose.

The finished product according to the present invention may comprise any number of desired extrudable food shapes depending upon the shape of the extruder die used. When the product is center-filled, the finished product may be filled with a cream, jelly or flavored fillings as discussed above. The resulting food product, in one embodiment, comprises no more than 2 grams of saturated fat per ounce serving

The following example is intended to further illustrate the practice of the invention and is not intended to limit the scope of the invention in any way unless otherwise indicated.

### EXAMPLE

A savory direct expanded food product with a center filling was prepared from the components of Table 2:

TABLE 2
Outer shell formulation

| Component | % |
|---|---|
| Whole Grain Corn Meal | 58 |
| Degermed Corn Meal | 25.5 |
| Trehalose | 16.5 |

100 pounds of ingredients were thoroughly blended as described above and fed to an extruder using a volumetric, co-rotating and intermeshing twin auger feeder, similar to a K-tron feeder. The trehalose-containing mixture blend was then extruded through a single screw short barrel extruder with a 10-14 inch screw and a barrel set up with an L/D ratio of 3.0 to 5.0. Screw speed was set to about 300 rpm and external heat was applied to the extruder to maintain a temperature at the die of about 150° C. during extrusion. The trehalose-containing mixture was extruded at a rate of 300 pounds/hour with a 12 inch threaded barrel.

The extrudate discharged through a die plate having a generally annular opening. As the extrudate emerged from the die plate, a small tube inserted the filling material into the center of the extruding tubular (or rope-like) dough and a post-former, attached at the die exit, provided for the shaping of the tubular dough. The composition of the filling material can be seen below in Table 3:

TABLE 3
Filling material formulation

| Components | % |
|---|---|
| Seasoning Powder | 60 |
| Corn Oil | 25 |
| Shortening | 15 |

The food product set shape upon cooling thereafter. The finished product comprised a texture that was crisp and crunchy, even though no drying oven or similar post extrusion thermal processing step was used.

Ranges may be expressed herein as from “about” or “approximately” one particular value and/or to “about” or “approximately” another particular value. When such a range is expressed, another embodiment comprises from the one particular value and/or to the other particular value. Similarly, when values are expressed as approximations, by use of the antecedent “about,” it will be understood that the particular value forms another embodiment.

As used herein, a weight percent of a component, unless specifically stated to the contrary, is based on the total weight of the formulation or composition in which the component is included.

Having thus described the present invention in some details by way of illustration and example, for purposes of clarity of understanding, it is to be appreciated that various alterations, modifications, and improvements will readily occur to those skilled in the art. Such alterations, modifications, and improvements are intended to be part of this disclosure, and are intended to be within the spirit and scope of the invention.

### ADDITIONAL DESCRIPTION

The following clauses are offered as further description of the disclosed invention.
1. A direct expanded savory food product comprising a farinaceous food material and a filling material, wherein said food product further comprises between about 3% to about 15% total sugars and a water activity of between about 0.25 to about 0.5.
2. The direct expanded food product according to any preceding clause, comprising a moisture content of less than about 5%, said food product not having been subjected to post-extrusion thermal processing.
3. The direct expanded food product according to any preceding clause, wherein said farinaceous food material is selected from the group consisting of meals, flours and starches derived from corn, wheat, rice, oats, barley, potatoes, tapioca, rye and other cereal crops, legumes, tubers or mixtures thereof.
4. The direct expanded food product according to any preceding clause, wherein said farinaceous food material comprises corn meal and wherein said filling material comprises one or more seasoning powders selected from cheese, chili pepper, maple syrup, caramel, dehydrated fruit powders, bacon, jalapeno, tomato, pizza, and BBQ.
5. The direct expanded food product according to any preceding clause, comprising no more than 2 grams of saturated fat.
6. The direct expanded food product according to any preceding clause, comprising a bulk density of between about 12.5 to about 15 pounds per cubic foot.
7. The direct expanded food product according to any preceding clause, comprising a force to break of between about 1.75 to about 3.5 pound force.
8. The direct expanded food product according to any preceding clause, comprising an outer shell of said farinaceous material with a porosity of between about 64% to about 77%.
9. The direct expanded food product according to any preceding clause, wherein said filling is enclosed within the center of said food product.
10. The direct expanded food product according to any preceding clause, comprising a ratio of volume of a filling material to total volume inside the shell of about 0.25 to about 0.35.
11. The direct expanded food product according to any preceding clause, comprising between about 0.01% to about 5% sweetness masker.

What is claimed is:

1. An extrudable dough comprising a farinaceous food material and a plasticizer in the form of trehalose.

2. The extrudable dough of claim 1 comprising a moisture content of less than about 5.5%.

3. The extrudable dough of claim 1 comprising between about 5% to about 25% trehalose.

4. The extrudable dough of claim 1 wherein said farinaceous food material is selected from the group consisting of meals, flours and starches derived from corn, wheat, rice, oats, barley, potatoes, tapioca, rye and other cereal crops, legumes, tubers or mixtures thereof.

5. The extrudable dough of claim 1 wherein said farinaceous food mixture comprises corn meal.

6. The extrudable dough of claim 1 wherein said farinaceous food material comprises whole grain corn meal.

7. The extrudable dough of claim 1 wherein said farinaceous food material comprises corn meal and whole grain corn meal.

8. The extrudable dough of claim 1 further comprising between about 0.01% to about 5% sweetness masker.

9. A crisp, direct expanded farinaceous food product made from the extrudable dough of claim 1, said food product comprising:
a water activity of between about 0.25 to about 0.5; and
between about 3% to about 15% total sugars.

10. A method for producing an expanded farinaceous food product, said method comprising:
mixing a farinaceous food material with a plasticizer component in the form of trehalose to form a trehalose-containing mixture; and
extruding said trehalose-containing mixture into an extrudate, thereby forming a snack food product.

11. The method of claim 10 wherein said mixing step produces a trehalose-containing mixture comprising between about 5% to about 25% trehalose.

12. The method of claim 10 wherein said farinaceous food material is selected from the group consisting of meals, flours and starches derived from corn, wheat, rice, oats, barley, potatoes, tapioca, rye and other cereal crops, legumes, tubers and mixtures thereof.

13. The method of claim 10 wherein said trehalose-containing mixture comprises from about 50% to about 95% corn meal.

14. The method of claim 10 wherein said farinaceous food material comprises corn meal and whole-grain corn meal.

15. The method of claim 10 wherein said trehalose-containing mixture comprises from about 50% to about 95% whole grain corn meal.

16. The method of claim 10 further comprising the step of introducing a filling material into said extrudate.

17. The method of claim 16 wherein said filling material is enclosed within the center of said extrudate.

18. The method of claim 16 wherein said filling material comprises a savory taste.

19. The method of claim 16 wherein said filling material comprises no more about 15% shortening.

20. The method of claim 16 wherein said filling comprises up to about 25% shortening, up to about 35% seasoning powder and up to about 35% oil.

21. The method of claim 16 wherein said filling comprises one or more of the following seasoning powders: cheese, chili pepper, capsaicin, maple syrup, or caramel.

22. The method of claim 10 further comprising the step of forming said extrudate into a plurality of smaller snack food products.

23. The method of claim 10 further comprising one or both of the steps of:
seasoning said snack food product; and
packaging said snack food product.

24. The method of claim 10 wherein said mixing step further comprises mixing between about 0.01% to about 5% sweetness masker into said trehalose-containing mixture.

25. A direct expanded savory food product comprising a farinaceous food material and a filling material, wherein said food product further comprises between about 3% to about 15% total sugars and a water activity of between about 0.25 to about 0.5.

26. The direct expanded food product of claim 25 comprising a moisture content of less than about 5.5%, said food product not having been subjected to post-extrusion thermal processing.

27. The direct expanded food product of claim 25 wherein said farinaceous food material is selected from the group consisting of meals, flours and starches derived from corn, wheat, rice, oats, barley, potatoes, tapioca, rye and other cereal crops, legumes, tubers or mixtures thereof.

28. The direct expanded food product of claim 25 wherein said farinaceous food material comprises corn meal and wherein said filling material comprises one or more seasoning powders selected from cheese, chili pepper, maple syrup, caramel, dehydrated fruit powders, bacon, jalapeno, tomato, pizza, and BBQ.

29. The direct expanded food product of claim 25 comprising no more than 2 grams of saturated fat.

30. The direct expanded food product of claim 25 comprising a bulk density of between about 12.5 to about 15 pounds per cubic foot.

31. The direct expanded food product of claim 25 comprising a force to break of between about 1.75 to about 3.5 pound force.

32. The direct expanded food product of claim 25 comprising an outer shell of said farinaceous material with a porosity of between about 64% to about 77%.

33. The direct expanded food product of claim 25 wherein said filling is enclosed within the center of said food product.

34. The direct expanded food product of claim 25 comprising a ratio of volume of filling material to total volume inside the shell of about 0.25 to about 0.35.

35. The direct expanded food product of claim 25 further comprising between about 0.01% to about 5% sweetness masker.
